(19) United States
(12) Patent Application Publication
(10) Pub. No.: US 2025/0043565 A1
(43) Pub. Date: Feb. 6, 2025

(54) Beam Mounting Bracket

(71) Applicant: Alpin Management Partners LTD, Charlestown (KN)

(72) Inventor: Andrew James Grant, Scrooby (GB)

(21) Appl. No.: 18/791,135

(22) Filed: Jul. 31, 2024

Related U.S. Application Data
(60) Provisional application No. 63/516,784, filed on Jul. 31, 2023.

(51) Int. Cl. E04B 1/38; F16B 2/06

(52) U.S. Cl. CPC E04B 1/388; F16B 2/065; E04B 2001/389

(57) ABSTRACT

A beam mounting bracket includes a body, a clamp plate, and a length adjustment mechanism. The body comprises a first end surface, a second end surface, and a bottom surface. The clamp plate comprises an inner surface and an outer surface. The length adjustment mechanism extends from the first end surface of the body. The clamp plate is positioned adjacent to the first end surface of the body and configured to be movable by the length adjustment mechanism.

### FIELD OF THE INVENTION

The present invention relates generally to mounting brackets. More specifically, the present invention is a beam mounting bracket for installing structures on an I-beam or H-beam. However, the present invention is not limited to this option, and it may further be adapted for different purposes.

### BACKGROUND OF THE INVENTION

An I-beam, which refers to various structural members with an I or H-shaped cross-section, is a versatile component commonly made of structural steel and widely used in construction. I-beams find applications as both beams and columns, serving a diverse range of construction needs. In industrial or commercial construction projects, I-beams are often utilized as the primary structural framework which is then covered with different materials for aesthetic purposes. One challenge faced when mounting lights between the flanges of I-beams is the requirement for welding or drilling. However, the proposed invention offers a solution that simplifies installation using only a wrench. Additionally, this invention provides the added convenience of easy relocation and re-installation.

### SUMMARY OF THE INVENTION

The present invention discloses a beam mounting bracket. The bracket comprises a body, a clamp plate, and a length adjustment mechanism. The body comprises a first end surface, a second end surface, and a bottom surface. The clamp plate comprises an inner surface and an outer surface. The length adjustment mechanism extends from the first end surface of the body. The clamp plate is positioned adjacent to the first end surface of the body and configured to be movable by the length adjustment mechanism.

In one embodiment, the length adjustment mechanism comprises a main bolt, and the body further comprises a main hole on the first end surface of the body. The main bolt comprises a head and a shaft, the head abutting against the inner surface of the clamp plate, and the shaft is threaded into the main hole.

In one embodiment, the head of the main bolt further comprises a round protrusion, and the clamp plate further comprises a positioning groove to receive the round protrusion.

In one embodiment, the length adjustment mechanism further comprises a main locknut to prevent the main bolt from slipping.

In one embodiment, the length adjustment mechanism further comprises a main washer arranged between the main locknut and the first end surface of the body.

In one embodiment, the present invention further comprises at least one tensioning mechanism. Each of the at least one tensioning mechanism comprises a threaded bolt, a spring, and a spring tensioning nut. The clamp plate comprises at least one hole to receive a first end of the threaded bolt. The body comprises at least one tensioning hole to receive a second end of the threaded bolt.

In one embodiment, the spring at one end abuts against the spring tensioning nut and at the other end abuts against the first end surface of the body.

In one embodiment, the at least one hole of the clamp plate is threaded.

In one embodiment, the at least one tensioning hole comprises a large diameter portion to receive the spring and a small diameter portion that allows the second end of the threaded bolt to travel through.

In one embodiment, each of the at least one tensioning mechanism further comprises a securing nut.

In one embodiment, each of the at least one tensioning mechanism further comprises a securing washer positioned between the securing nut and the inner surface of the clamp plate.

In one embodiment, the at least one tensioning mechanism comprises two tensioning mechanisms positioned on either side of the length adjustment mechanism.

In one embodiment, the body further comprises at least one cutout portion adjacent to the second end surface of the body, the at least one cutout portion being configured to receive the second end of the threaded bolt.

In one embodiment, the present invention further comprises a transit nut that is threaded onto the second end of the threaded bolt.

In one embodiment, the bottom surface of the body comprises at least one mounting hole.

In one embodiment, a bottom surface of the clamp plate comprises at least one mounting hole.

In one embodiment, the second end surface of the body is knurled.

In one embodiment, the outer surface of the clamp plate is knurled.

In one embodiment, the length adjustment mechanism is further configured to apply a force to the clamp plate.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of the present invention.

FIG. 2 depicts another perspective view of the present invention.

FIG. 3 depicts an exploded view of the present invention.

FIG. 4 depicts an exploded perspective view of the present invention.

FIG. 5 depicts another exploded perspective view of the present invention.

FIG. 6 depicts a front view of the present invention.

FIG. 7 depicts a cross-sectional view of the present invention, taken along the line A-A in FIG. 6.

FIG. 8 depicts a cross-sectional view of the present invention, taken along the line B-B in FIG. 6.

FIG. 9 depicts a rear view of the present invention.

FIG. 10 depicts another front view of the present invention, wherein a plurality of transit nuts are shown.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of mounting brackets, embodiments of the present disclosure are not limited to use only in this context.

The present invention is a beam mounting bracket that is specifically designed for I-beams or H-beams. It is an aim of the present invention to provide a mounting bracket that helps mount, for example a light fixture in-between H-beam or I-beam flanges. It is another aim of the present invention to provide a mounting bracket that allows users to mount the light fixture without drilling or welding. It is yet another aim of the present invention to provide a mounting bracket that is simple in structure, inexpensive to manufacture, and easy to use.

Referring now to the figures of the present disclosure. The beam mounting bracket of the present invention comprises a body 110, a clamp plate 140, and a length adjustment mechanism 170.

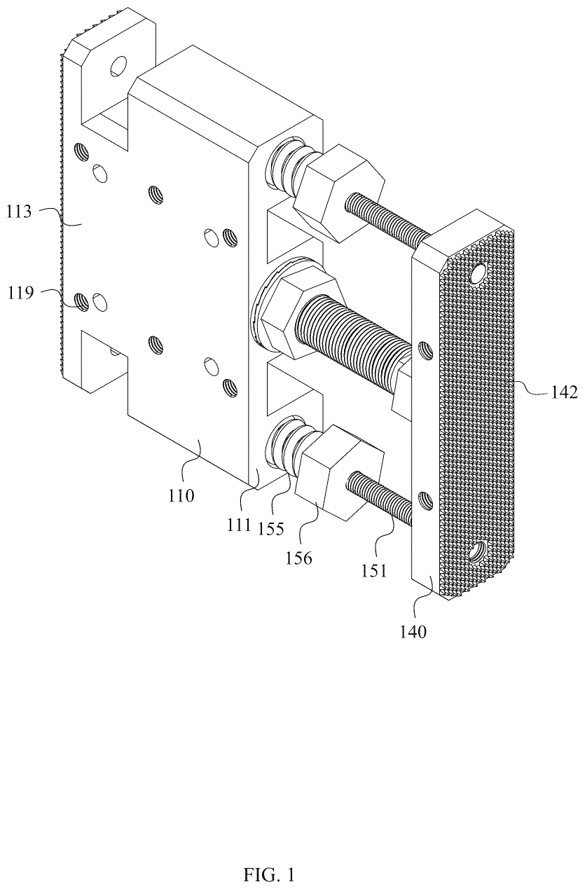

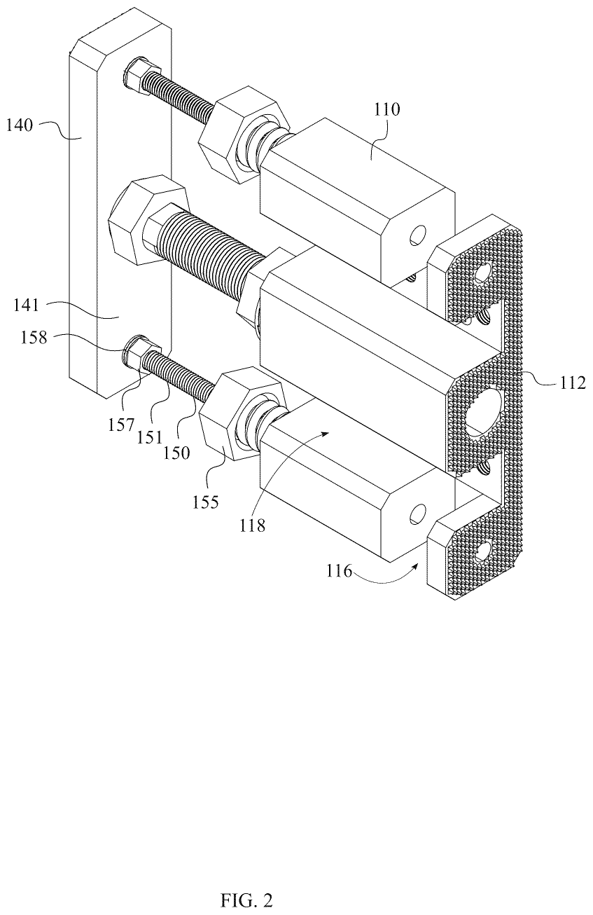

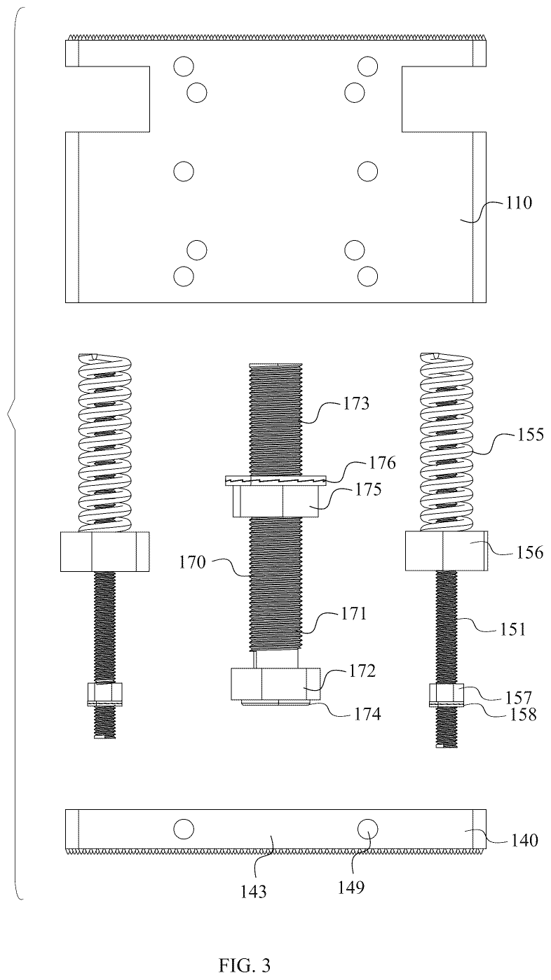

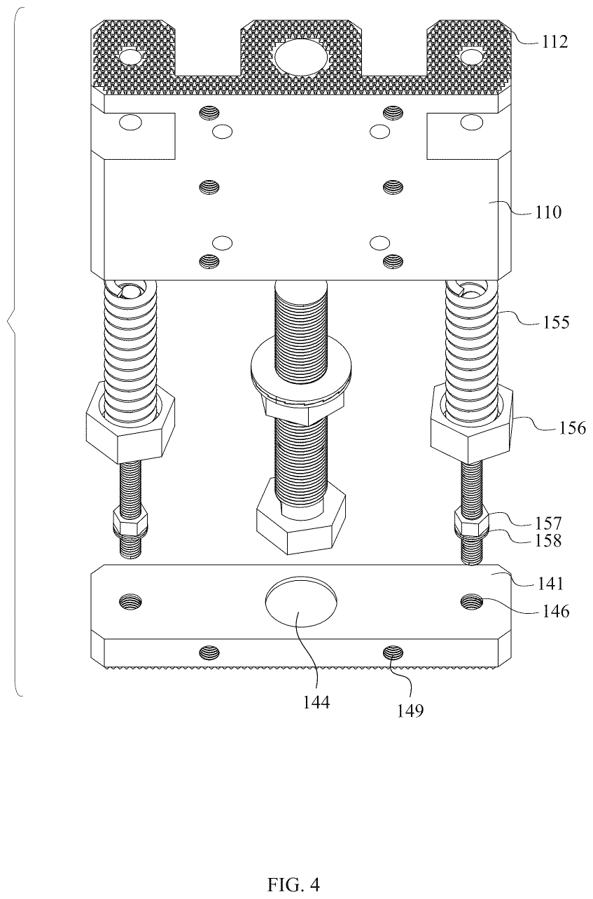

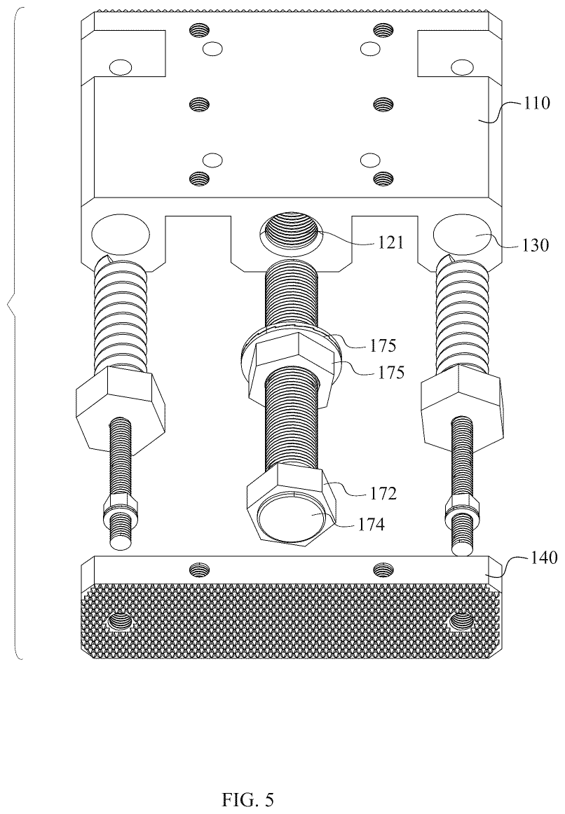

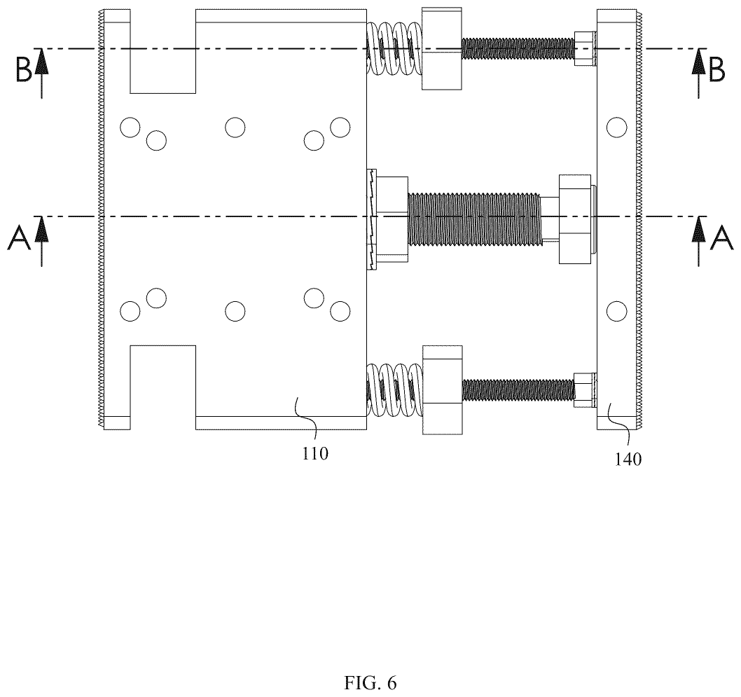

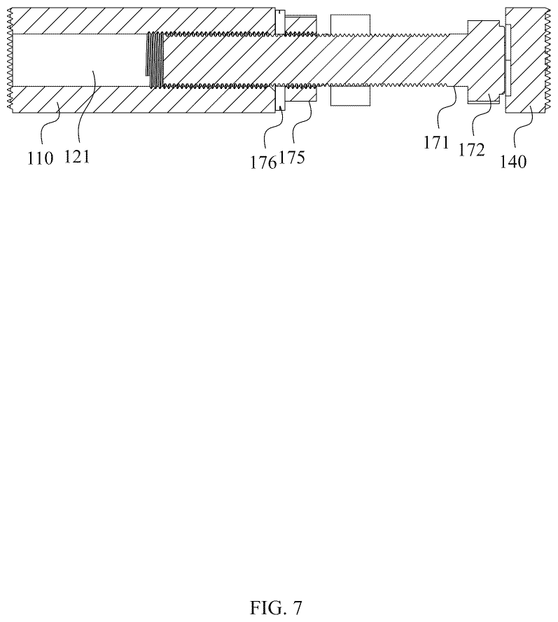

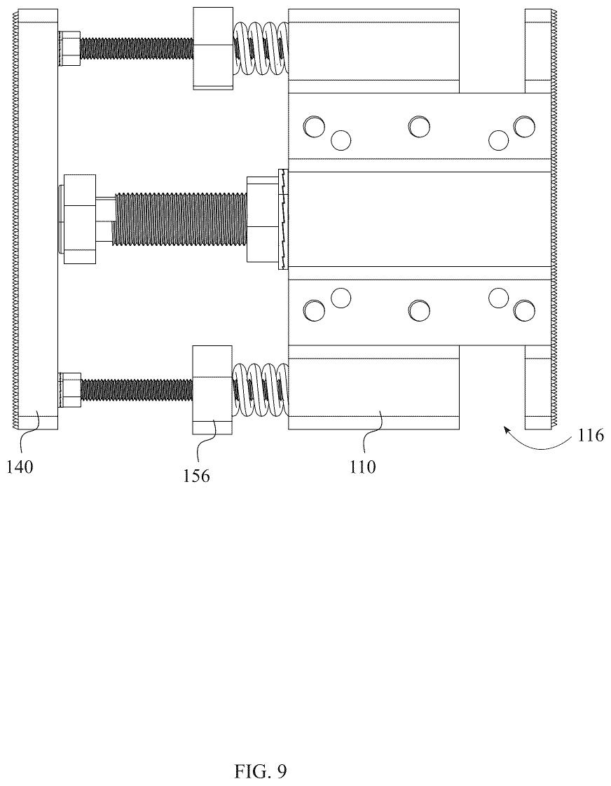

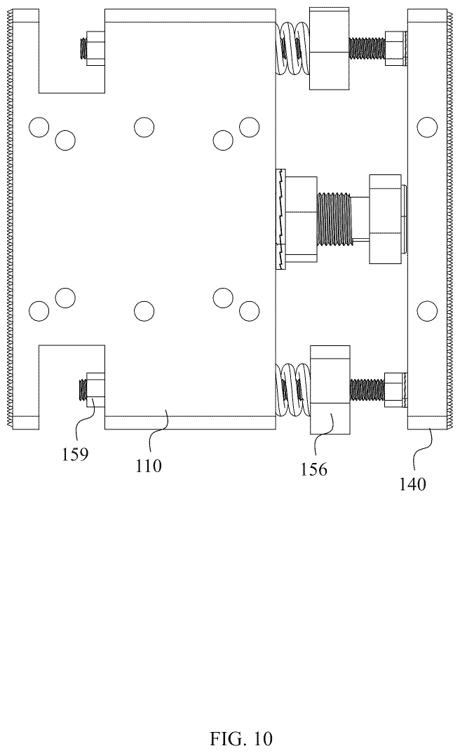

As shown in FIGS. 1-10, the body 110 comprises a first end surface 111, a second end surface 112, and a bottom surface 113. It should be noted that the body 110 can be of any shape, size, material, features, type or kind, orientation, location, quantity, components, and arrangements of components that would allow the present invention to fulfill the objectives and intents of the present invention. The first end surface 111 of the body 110 is configured to receive the length adjustment mechanism 170 and optional tensioning mechanism 150, which will be described in more detail hereinafter. The second end surface 112 is configured to engage one flange of the I-beam or H-beam. Preferably, the second end surface 112 of the body 110 is knurled to increase the frictional contact of the body 110 with the flange of the I-beam or H-beam. The bottom surface 113 of the body 110 comprises at least one mounting hole 119 such that a light fixture or other devices can be secured to the body 110 via a bolt, a screw, or any other suitable means. Although in the illustrated embodiment, the body 110 has a substantially square shape with rounded edges, it is contemplated that other shapes (e.g., other polygons) are also possible. Moreover, in one embodiment, the body 110 may have a plurality of longitudinal cutouts 118 to reduce the overall weight of the body 110 while still maintaining its structural integrity.

As shown in FIGS. 1-10, the clamp plate 140 comprises an inner surface 141 and an outer surface 142. It should be noted that clamp plate 140 can be of any shape, size, material, features, type or kind, orientation, location, quantity, components, and arrangements of components that would allow the present invention to fulfill the objectives and intents of the present invention. In one embodiment, the clamp plate 140 is positioned adjacent to the first end surface 111 of the body 110 and configured to be movable by the length adjustment mechanism 170, which will be described in more detail hereinafter. The outer surface 142 of the clamp plate 140 is configured to engage the other flange of the I-beam or H-beam. With the outer surface 142 of the clamp plate 140 and the second end surface 112 of the body 110 engaging the two flanges, the present invention is positioned and secured within the flanges of the I-beam or H-beam. Similar to the second end surface 112, the outer surface 142 of the clamp plate 140 may also be knurled. Moreover, in one embodiment, the bottom surface 143 of the clamp plate 140 may comprise at least one mounting hole 149 to assist in the installation of the light fixture or other devices.

The length adjustment mechanism 170 is configured to adjust the length of the present invention, allowing it to be used with I-beams or H-beams of various sizes. The length adjustment mechanism may be further configured to apply a force to the clamp plate. In one embodiment, the length adjustment mechanism 170 extends from the first end surface 111 of the body 110. The length adjustment mechanism 170 may be any mechanism that is suitable to move the clamp plate 140 and/or apply a force to the clamp plate 140 to securely mount the bracket of the present invention within the flanges of I-beams or H-beams. In a preferred embodiment, the length adjustment mechanism 170 comprises a main bolt 171, and the body 110 further comprises a main hole 121 on the first end surface 111 of the body 110 to receive the main bolt 171. The main hole 121 is threaded. In this embodiment, the main bolt 171 comprises a head 172 and a shaft 173. The head 173 abuts against the inner surface 141 of the clamp plate 140. The shaft 173 is threaded into the main hole 121. In this way, by tightening or loosening the main bolt 171, the clamp plate 140 may be moved towards or away from the second end surface 112 of the body 110, and thus the length of the present invention can be adjusted.

In one embodiment, the head 172 of the main bolt 171 further comprises a round protrusion 174. In this embodiment, the clamp plate 140 further comprises a positioning groove 144 to receive the round protrusion 174. The positioning groove 144 may also have a round shape. Preferably, the positioning groove 144 is concentric with the round protrusion 174 and sized to be slightly larger than the round protrusion 174 such that the round protrusion 174 can rotate in the positioning groove 144. In a preferred embodiment, the length adjustment mechanism 170 further comprises a main locknut 175 to prevent the main bolt 171 from slipping. In this embodiment, the main locknut 175 may be a hexagon-shaped nut with a threaded inner wall that engages the main bolt 171. The main locknut 175 is positioned along the main bolt 171 and can be easily rotated with a standard wrench to secure the main bolt 171. In one embodiment, the length adjustment mechanism 170 further comprises a main washer 176 arranged between the main locknut 175 and the first end surface 111 of the body 110. The main washer 176 is a circular shaped object.

In one embodiment, the present invention further comprises at least one tensioning mechanism 150. The at least one tensioning mechanism 150 is configured to apply an outward force on the clamp plate 140 and the body 110 so as to assist in securely holding the present invention between the flanges of an I-beam or H-beam. It should be noted that the tensioning mechanism 150 can be of any shape, size, material, features, type or kind, orientation, location, quantity, components, and arrangements of components that would allow the present invention to fulfill the objectives and intents of the present invention. However, in a preferred embodiment, each of the at least one tensioning mechanism 150 comprises a threaded bolt 151, a spring 155, and a spring tensioning nut 156. Moreover, the clamp plate 140 may further comprise at least one hole 146 to receive a first end 152 of the threaded bolt 151, and the body 110 may further comprise at least one tensioning hole 130 to receive a second end 153 of the threaded bolt 151. In one embodiment, the at least one hole 146 of the clamp plate is threaded such that the first end 152 of the threaded bolt 151 can be threaded into the at least one hole 146. In this embodiment, each of the at least one tensioning mechanism 170 may further comprise a securing nut 157. Further, each of the at least one tensioning mechanism 170 may further comprise a securing washer 158 positioned between the securing nut 157 and the inner surface 141 of the clamp plate 140. The securing nut 157, together with the securing washer 158, when tightened prevents the threaded bolt 151 from rotating. In another embodiment, the first end first end 152 of the threaded bolt 151 is fixed into the at least one hole 146.

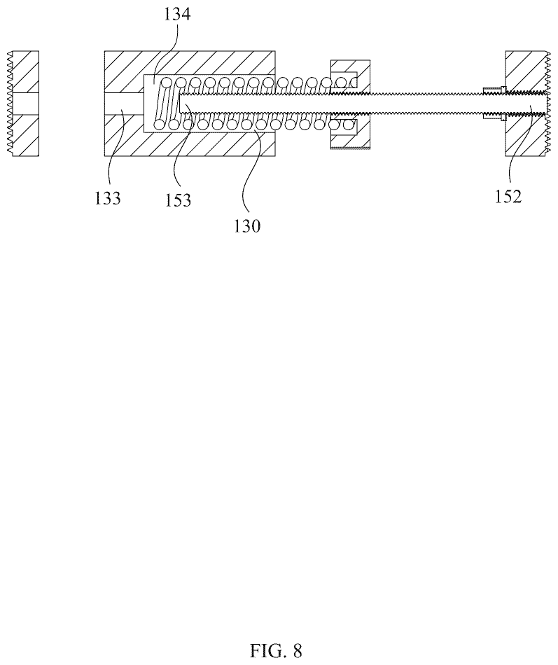

The spring 155 at one end abuts against the spring tensioning nut 156 and at the other end abuts against the first end surface 111 of the body 110. In a preferred embodiment, the at least one tensioning hole 130 comprises a large diameter portion 133 to receive the spring 155 and a small diameter portion 134 that allows the second end 153 of the threaded bolt 151 to travel through, as shown in FIG. 8. Preferably, the at least one tensioning mechanism 150 comprises two tensioning mechanisms positioned on either side of the length adjustment mechanism 170.

In one embodiment, the body 110 further comprises at least one cutout portion 116 adjacent to the second end surface 112 of the body 110. The at least one cutout portion is configured to receive the second end 153 of the threaded bolt 151. In this embodiment, the present invention may further comprise at least one transit nut 159 that is threaded onto the second end 153 of the threaded bolt 151. The at least one transit nut 159 can hold the components of the present invention together and prevent the clamp plate 140 from accidentally disengaging the body 110.

In order to mount the present invention within the flanges of an I-beam or H-beam, the main bolt 171 may first be rotated to meet the clamp plate 140 to a desired. Then the present invention may be placed between the flanges of an I-beam or H-beam. Once the securing nut 157 of the tensioning mechanism 150 is tightened, the spring tensioning nut 156 may be fully tightened. At this point, the present invention should be held in position because of the force applied by the springs. Then the main bolt 171 is tightened to for example a torque of 105 ft-lbs. Lastly, the main locknut 175 is fully tightened to securely mount the present invention within the flanges of an I-beam or H-beam.

It should be noted that the present invention may be made of any suitable material, but preferably made of metal (e.g., aluminum, etc.). It is also envisioned that the sizes of the components forming the present invention such as the body 110, and/or the clamp plate 140 can vary based on design requirements.

Although the disclosure has been explained in relation to its preferred embodiment, it is to be understood that many other possible modifications and variations can be made without departing from the spirit and scope of the disclosure.

What is claimed is:

1. A beam mounting bracket, comprising
a body comprising a first end surface, a second end surface, and a bottom surface;
a clamp plate comprising an inner surface and an outer surface;
a length adjustment mechanism extending from the first end surface of the body;
the clamp plate being positioned adjacent to the first end surface of the body and configured to be movable by the length adjustment mechanism.

2. The beam mounting bracket as claimed in claim 1, wherein the length adjustment mechanism comprises a main bolt, and the body further comprises a main hole on the first end surface of the body, the main bolt comprising a head and a shaft, the head abutting against the inner surface of the clamp plate, and the shaft being threaded into the main hole.

3. The beam mounting bracket as claimed in claim 2, wherein the head of the main bolt further comprises a round protrusion, and the clamp plate further comprises a positioning groove to receive the round protrusion.

4. The beam mounting bracket as claimed in claim 3, wherein the length adjustment mechanism further comprises a main locknut to prevent the main bolt from slipping.

5. The beam mounting bracket as claimed in claim 4, wherein the length adjustment mechanism further comprises a main washer arranged between the main locknut and the first end surface of the body.

6. The beam mounting bracket as claimed in claim 1, further comprising:
at least one tensioning mechanism;
each of the at least one tensioning mechanism comprising a threaded bolt, a spring, and a spring tensioning nut;
the clamp plate comprising at least one hole to receive a first end of the threaded bolt;
the body comprising at least one tensioning hole to receive a second end of the threaded bolt.

7. The beam mounting bracket as claimed in claim 6, wherein the spring at one end abuts against the spring tensioning nut and at the other end abuts against the first end surface of the body.

8. The beam mounting bracket as claimed in claim 6, wherein the at least one hole of the clamp plate is threaded.

9. The beam mounting bracket as claimed in claim 7, wherein the at least one tensioning hole comprising a large diameter portion to receive the spring and a small diameter portion that allows the second end of the threaded bolt to travel through.

10. The beam mounting bracket as claimed in claim 7, wherein each of the at least one tensioning mechanism further comprises a securing nut.

11. The beam mounting bracket as claimed in claim 10, wherein each of the at least one tensioning mechanism further comprises a securing washer positioned between the securing nut and the inner surface of the clamp plate.

12. The beam mounting bracket as claimed in claim 7, wherein the at least one tensioning mechanism comprises two tensioning mechanisms positioned on either side of the length adjustment mechanism.

13. The beam mounting bracket as claimed in claim 7, wherein the body further comprises at least one cutout portion adjacent to the second end surface of the body, the at least one cutout portion being configured to receive the second end of the threaded bolt.

14. The beam mounting bracket as claimed in claim 13, further comprising a transit nut that is threaded onto the second end of the threaded bolt.

15. The beam mounting bracket as claimed in claim 1, wherein the bottom surface of the body comprises at least one mounting hole.

16. The beam mounting bracket as claimed in claim 1, wherein a bottom surface of the clamp plate comprises at least one mounting hole.

17. The beam mounting bracket as claimed in claim 1, wherein the second end surface of the body is knurled.

18. The beam mounting bracket as claimed in claim 1, wherein the outer surface of the clamp plate is knurled.

19. The beam mounting bracket as claimed in claim 1, wherein the length adjustment mechanism is further configured to apply a force to the clamp plate.
